(19) United States
(12) Patent Application Publication
(10) Pub. No.: US 2013/0212501 A1
(43) Pub. Date: Aug. 15, 2013

(54) PERCEPTUAL COMPUTING WITH CONVERSATIONAL AGENT

(71) Applicants: Glen J. Anderson, Portland, OR (US); Gila Kamhi, Zichron Yaakov (IL); Rajiv K. Mongia, Redwood City, CA (US); Yosi Govezensky, Nofit (IL); Barak Hurwitz, Kibbutz Alonim (IL); Amit Moran, Tel Aviv (IL); Ron Ferens, Ramat Hasharon (IL)

(72) Inventors: Glen J. Anderson, Portland, OR (US); Gila Kamhi, Zichron Yaakov (IL); Rajiv K. Mongia, Redwood City, CA (US); Yosi Govezensky, Nofit (IL); Barak Hurwitz, Kibbutz Alonim (IL); Amit Moran, Tel Aviv (IL); Ron Ferens, Ramat Hasharon (IL)

(21) Appl. No.: 13/724,992

(22) Filed: Dec. 21, 2012

Related U.S. Application Data
(60) Provisional application No. 61/597,591, filed on Feb. 10, 2012.

(51) Int. Cl. G06F 3/0484

(52) U.S. Cl. CPC G06F 3/0484
USPC 715/764

(57) ABSTRACT

Perceptual computing with a conversational agent is described. In one example, a method includes receiving a statement from a user, observing user behavior, determining a user context based on the behavior, processing the user statement and user context to generate a reply to the user, and presenting the reply to the user on a user interface.

### RELATED APPLICATIONS

This application claims the benefit of U.S. Provisional Application No. 61/597,591 filed Feb. 10, 2012, which is hereby incorporated by reference.

### FIELD

The present disclosure relates to simulated computer conversation systems and, in particular to presenting natural interaction with a conversational agent.

### BACKGROUND

Human interactions with computers are hampered because computers do not act human. It has been difficult to produce a real product that actually does a good job of carrying on a conversation with a human. It is also difficult to produce a computer that is able to interpret human facial expressions and body language while doing so.

Computing systems can allow users to have conversational experiences that make the computer seem like a real person to some extent. Siri (a service of Apple, Inc.) has a very limited capability in this respect. At present, it presents canned responses to a set of questions. Evie (Electronic Virtual Interactive Entity) and Cleverbot created by Existor, Ltd. use technology that is much deeper in this respect. This technology leverages a database of millions of previous conversations with people to allow the system to carry on a more successful conversation with a given individual. It also uses heuristics to select a particular response to the user. For example, one heuristic weighs a potential response to user input more heavily if that response previously resulted in longer conversations. In the Existor systems, longer conversations are considered to be more successful. Therefore, responses that increase conversation length are weighed more heavily.

### BRIEF DESCRIPTION OF THE DRAWING FIGURES

Embodiments of the invention are illustrated by way of example, and not by way of limitation, in the figures of the accompanying drawings in which like reference numerals refer to similar elements.

FIG. 1 is a diagram of a display of an interactive computer interface within a web interface with an avatar and a text box for communication.

FIG. 2 is a diagram of the interactive computer interface of FIG. 1 in which the text box relates to facial expressions.

FIG. 3 is a block diagram of a computing system with user input and interpretation according to an embodiment of the present invention.

FIG. 4 is a process flow diagram of presenting natural interaction with a perceptual agent according to an embodiment of the invention.

FIG. 5 is a diagram of user terminals communicating with a server conversation system according to an embodiment.

FIG. 6 is a process flow diagram of presenting natural interaction with a perceptual agent according to another embodiment of the invention.

FIG. 7 is a block diagram of a computer system suitable for implementing processes of the present disclosure according to an embodiment of the invention

### DETAILED DESCRIPTION

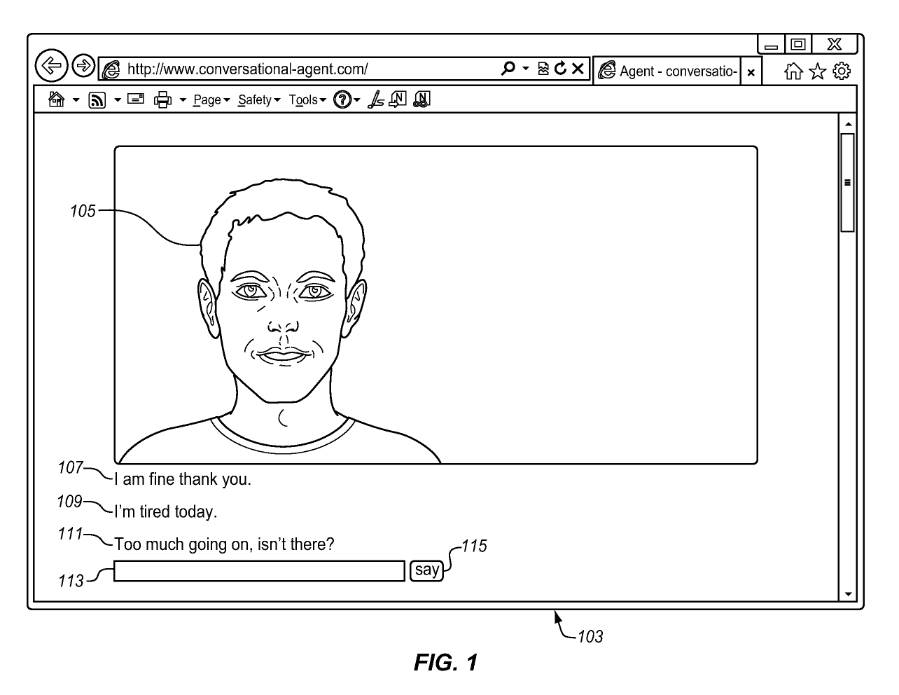

FIG. 1 is a diagram of an interactive computer interface in the form of a web browser interface 103. The interface presents the computer output as an avatar 105 in the form of a human head and shoulders that provides facial expressions and spoken expressions. The spoken expressions may also be presented as text 107, 111. Similarly, the user's input may also be presented as text 109 and a text entry box 113 is provided for additional user input. A “say” button 115 allows the user to send typed text to the computer user interface.

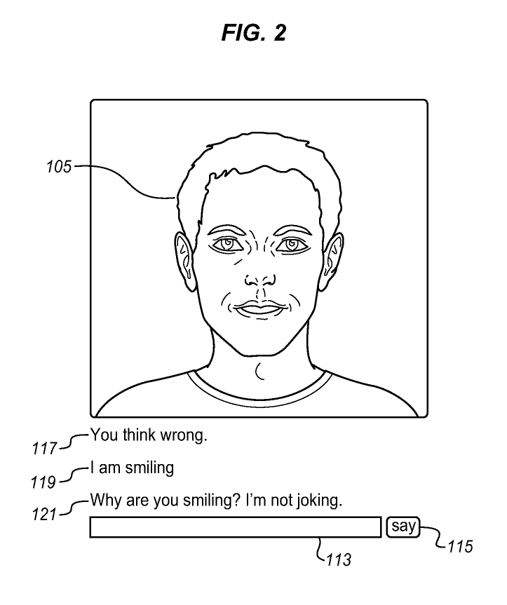

An interface like that of FIG. 1 has many limitations. For example, it is not aware of user facial expressions, so, for example, it cannot react to smiling. In the example of FIG. 2, the conversational agent has generated a response 117 and the user has typed in a statement “I am smiling.” 119. This input might also be generated with a selection from a drop down list or set of displayed emotion buttons. The computer generates a response 121 appropriate to this statement but has no ability to receive the input “I am smiling” other than by it being typed in by the user.

In addition to not being able to independently determine emotions, such a system has no other user information. As an example, it has no access to data on the user (interests, calendar, email text, etc.) or the user's context (location, facial expressions, etc.) to allow more customized discussions.

Additional APIs may be added to a conversational database system to acquire more contextual cues and other information to enrich a conversation with a user. This additional information could include physical contextual cues (when appropriate):

User's facial expressions

Local (to the user) emotion tracking information (cross modality)

User gestures, posture, and body position such as sitting, standing, and use in conversation

User eye tracking (for data on both what the user is looking at on an image and what a user has read)

User touch and pressure input on a touch sensitive surface

Measures of user tension, such as heart rate and galvanic skin response

Measure of user fatigue, such as eye movements and posture

User voice tone and volume, emotion

User attention level

User location

Face recognition

Clothing recognition—and conversations related to that

Head tracking—personal space and what it means

Information on environmental surroundings, indoors, weather outside, background sounds

Multiple user—array microphones, voice recordings, who is talking—move to look at person talking,

Eye tracking and attention—user looks at you, eye contact

User category—age, gender, nationality, (conversation may be different by age)

Startled responses

The additional information could also include user data that is available on a user's computing devices or over a network, potentially including:

Text from the user's previous email

User browsing, shopping, medical data, etc.

Tracking of other user's physical or information cues

User data from the currently used device or from other devices connected over a network

The information above could be from concurrent activity or historical information could be accessed. The APIs could exist on the local user device or on a server-based system or both.

Such a system with additional APIs may be used to cover conversations and more practical activities like launching applications, asking for directions, asking for weather forecasts (using voice) from the device. When coupled with the functionality described above, the system could switch between conversational responses and more practical ones. In the near term, it could be as simple as resorting to the conversational database algorithms when the request is not understood. In a more complex version, the algorithms would integrate conversation with practical answers. For example, if the user frowns at a result, the system may anticipate that the system's response was wrong and then ask the user via the conversational agent if the system did not get a satisfactory answer. The conversational agent might apologize in a way that made the user laugh on a previous occasion and then make an attempt to get additional input from the user.

In some embodiments:

APIs allow the gathered data to be interfaced with the conversation database (which has its own algorithms on replies to conversation)

A combined set of algorithms work across both the individual items above and the conversation database's algorithms

Examples of combined algorithms:

A smile is detected with a spoken statement. If the content analysis of the spoken statement does not allow for a highly weighted response, ask the user if the user is kidding.

Sadness is detected when a text input says everything is ok. The sadness is more heavily weighted than the content of the statement.

Eye tracking shows the user looking away while the user's voice and another voice can be detected. Weigh the likelihood of non-attention to the conversational agent higher.

A heavier weighting to use in future conversations given to responses that elicit threshold changes in emotion detection (e.g., a 50 percent or greater change in balance between neutral and happy would get a very high rating).

Some embodiments may include:

Database APIs

Conversational agent for permission to summarize conversations to others

A weighting system that estimates user attention to the conversational avatar

The avatar can initiate conversations by asking the user about facial expressions

A measure of user attention level to the onscreen avatar allows

Uses:

Use of the system in a game, for example to allow conversation during a game with a computer-based team mate

Conversation agent for entertainment

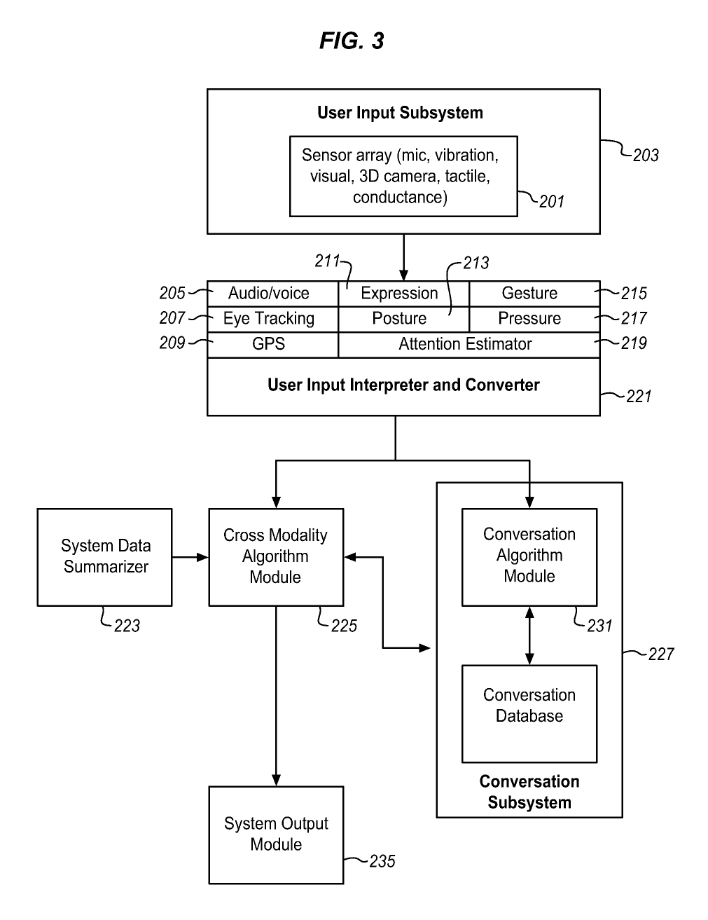

Implementations may include some of the following as shown in the example of FIG. 3 which shows a computing system with screen, speakers, 3D visual sensor, microphone and more. A User Input Subsystem 203 receives any of a wide range of different user inputs from a sensor array 201 or other sources. The sensor array may include microphones, vibration sensors, cameras, tactile sensors and conductance sensors. The microphones and cameras may be in an array for three-dimensional (3D) sensing. The other sensors may be incorporated into a pointing device or keyboard or provided as separate sensors.

The collected data from the user input subsystem 203 is provided to a user input interpreter and converter 221. Using the user inputs, the interpreter and converter 221 generates data that can be processed by the rest of the computing system. The interpreter and converter includes a facial expression tracking and emotion estimation software module, including expression tracking using the camera array 211, posture tracking 213, GSP 209 and eye tracking 207. The interpreter and converter may also include a face and body tracking (especially for distance) software module, including eye tracking 207 posture tracking 213, and an attention estimator 219. These modules may also rely on the camera or camera array of the user input subsystem. The interpreter and converter may also include gesture tracking hardware (HW) and software (SW) 215, a voice recognition module 205 that processes incoming microphone inputs and an eye tracking subsystem 207 that relies on the cameras.

The User Input Interpreter and Converter 221 also includes an Attention Estimator 219. This module determines the user's attention level based on eye tracking 207, time from last response, presence of multiple individuals, and other factors. All of these factors may be determined from the camera and microphone arrays of the user input subsystem. As can be understood from the foregoing, a common set of video and audio inputs from the user input subsystem may be analyzed in many different ways to obtain different information about the user. Each of the modules of the User Input Interpreter and Converter 221, the audio/video 205, the eye tracking 207, the GPS (Global Positioning System) 209, the expression 211, the posture 213, the gesture 215, and the attention estimator allow the same camera and microphone information to be interpreted in different ways. The pressure module 217 may use other types of sensors, such as tactile and inductance to make interpretations about the user. More or fewer sensors and interpretation modules may be used depending on the particular implementation.

All of the above interpreted and converted user inputs may be applied as inputs of the computing system. More or fewer inputs may be used depending on the particular implementation. The converted inputs are converted into a form that is easily used by the computing system. These may be textual descriptions, demographic information, parameters in APIs or any of a variety of other forms.

A Conversation Subsystem 227 is coupled to the User Input Interpreter and Converter 221 and receives the interpreted and converted user input. This system already has a database of previous conversations 233 and algorithms 231 to predict optimal responses to user input. The conversation database may be developed using only history within the computing system or it may also include internal data. It may include conversations with the current user and with other users. The conversation database may also include information about conversations that has been collected by the System Data Summarizer 223. This subsystem may also include a text to voice subsystem to generate spoken responses to the user and a text to avatar facial movement subsystem to allow an avatar 105 of the user interface to appear to speak.

A System Data Summarizer 223 may be provided to search email and other data for contacts, key words, and other data. The system data may appear locally, on remote servers, or on the system that hosts the avatar. Messages from contacts may be analyzed for key words that indicate emotional content of recent messages. In addition, location, travel, browsing history, and other information may be obtained.

A Cross-Modality Algorithm Module 225 is coupled to the System Data Summarizer and the User Input Interpreter and Converter. The Cross-Modality Algorithm Module serves as a coordination interface between the Conversation Subsystem 227, to which it is also coupled, the User Input Subsystem 203, and the System Data Summarizer 223. This subsystem receives input from the User Input Subsystem 203 and System Data Summarizer 223 and converts that input into a modality that may be used as a valid input to the Conversation Subsystem 227. Alternatively, the Conversation Subsystem may be used as one of multiple inputs to its own algorithms.

The conversation developed in the Conversation Subsystem 227 may be provided to the Cross Modality Algorithm Module 235. This module may then combine information in all of the modalities supported by the system and provide this to the System Output Module 235. The System Output Module generates the user reaction output such as an avatar with voice and expressions as suggested by FIGS. 1 and 2.

In the example of FIG. 3, the computing system is shown as a single collection of systems that communicate directly with one another. Such a system may be implemented as a single integrated device, such as a desktop, notebook, slate computer, tablet, or smart phone. Alternatively, one or more of the components may be remote. In one example, all but the User Input Subsystem 203 and the System Output Module 235 are located remotely. Such an implementation is reflected in the web browser based system of FIG. 1. This allows the local device to be simple, but requires more data communication. The System Data Summarizer 223 may also be located with the user. Any one or more of the other modules 221, 225, 227 may also be located locally on the user device or remotely at a server. The particular implementation may be adapted to suit different applications.

In a basic implementation, the Coordination Interface 225 may simply create a text summary of the information from the User Input Subsystem 203 and send the text to the Conversation Subsystem 227. For example, in the example of FIG. 2 the user has typed “I am smiling,” 119 and the avatar has responded accordingly, “Why are you smiling? I am not joking” 121. If the “I am smiling” input could be automatically input, the experience would immediately be much more interesting, since it would seem that the avatar is responding to the user's smile.

In another implementation, input from the User Input Subsystem 203 would be more integrated in the algorithms of the Conversation Subsystem 227.

The system could create new constructs for summary to the Conversation Subsystem. For example, an attention variable could be determined by applying weighting to user statements based on behavior. This and similar ideas may be used by computer manufacturers and suppliers, graphics chips companies, operating system companies, and independent software or hardware vendors, etc.

Considering the system of FIG. 3 in more detail, the User Input Subsystem 203 is able to collect current user information by observation and receive a variety of different inputs. As shown, the user inputs may be by visual or audio observation or by using tactile and touch interfaces. In addition, accelerometers and other inertial sensors may be used. The information collected by this subsystem can be immediate and even simultaneous with any statement received from the user. The information from the User Input Subsystem is analyzed at the User Input Interpreter and Converter 221. This subsystem includes hardware and systems to interpret the observations as facial expressions, body posture, focus of attention from eye tracking and similar kinds of interpretations as shown. Using these two systems, a received user statement can be associated with other observations about the user. This combined information can be used to provide a richer or more natural experience for the user. One or even all of the listed determinations may be used and compared to provide a more human-like interpretation of the user's statement. While the User Input Interpreter and Converter are shown as being very close to the User Input Subsystem, this part of the system may be positioned at the user terminal for speed or at a separate larger system such as a server for greater processing power.

The System Output Module 235 and the Conversation Subsystem 227, upon receiving the data from the User Input Interpreter and Converter 221 may provide additional interaction simply to understand the received data. It can happen that a user statement does not correlate well to the observed user behavior or to the conversation. A simple example of such an interaction is shown in FIG. 2 in which the user is smiling but there has been no joking. The user may be smiling for any other reason and by presenting an inquiry to the user, the reason for the smiling can be determined. It may also be that the user's facial expression or some other aspect of the user's mood as determined by the User Input Interpreter and Converter is not consistent. The Conversation Subsystem can determine how to interpret this inconsistency by presenting an inquiry to the user. This may be done by comparing the user statement to the determined user mood to determine if they are consistent. If the two are not consistent, then an inquiry can be presented to the user to explain the inconsistency.

Such an inquiry may also be presented without such a comparison, the User Input Interpreter and Converter may receive an observation of a user facial expression at the time that it receives a user statement. The user facial expression will be interpreted as an associated user mood. The Conversational Subsystem or the User Input Interpreter and Converter may then present an inquiry to the user regarding the associated user mood. The inquiry may be something like “are you smiling” “are you happy” “feeling tense aren't you” or a similar such inquiry. The user response may be used as a more certain indicator of the user's mood than what might be determined without an inquiry.

The User Input Interpreter and Converter also shows a GPS module 209. This is shown in this location to indicate that the position of interest is the position of the user which is usually very close to the position of the terminal. This is a different type of information from the observations of the user but can be combined with the other two types or modes of information to provide better results. The position may be used not only for navigational system support and local recommendations but also to determine language, units of measure and local customs. As an example, in some cultures moving the head from side to side means no and in other cultures it means yes. The user expression or gesture modules may be configured for the particular location in order to provide an accurate interpretation of such a head gesture.

The GPS module may also be used to determine with the user terminal is moving and how quickly. If the user terminal is moving at fairly constant 80 km/h, the system may infer that the user is driving or riding in an automobile. This information may be used to adapt the replies to those that are appropriate for driving. As an example the conversational agent may reply in a way that discourages eye contact with the avatar . . . . Alternatively, the user terminal travels at 50 km/h with frequent stops, then the system may infer that the user is riding a bus and adapt accordingly. A bus schedule database may be accessed to provide information on resources close to the next bus stop.

The System Data Summarizer 223 presents another modality for augmenting the user interaction with the conversational agent. The System Data Summarizer finds stored data about the user that provides information about activities, locations, interests, history, and current schedule. This information may be local to a user terminal or remote or both. The stored data about the user is summarized and a summary of the stored data is provided to the Cross Modality Module. The data in this modality and others may be combined with the data from the User Input Interpreter and Converter in the Cross Modality Algorithm Module 225. In this example, user appointments, user contact information, user purchases, user location, and user expression may all be considered as data in different modalities. All of this user data may be helpful in formulating natural replies to the user at the Conversation Subsystem 227. The Cross Modality Algorithm Module can combine other user inputs with information from the user input subsystem with a user statement and any observed user behavior and provide the combined information to the Conversation Subsystem 2270.

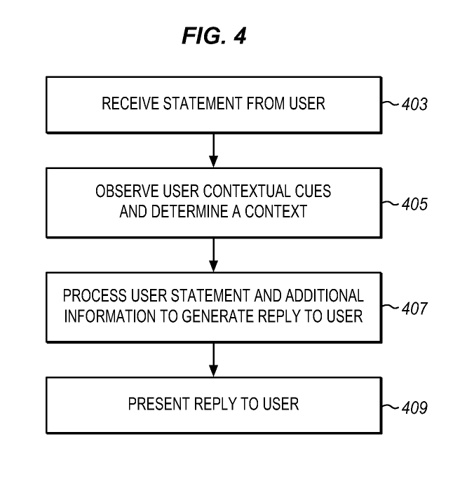

FIG. 4 is a process flow diagram of presenting a natural interface with an artificial conversational agent. At 403 a user terminal receives a statement from a user. The statement may be spoken or typed. The statement may also be rendered by a user gesture observed by cameras or applied to a touch surface. The user terminal may include a conversational agent or the conversational agent may be located remotely and connected to the user terminal through a wired or wireless agent.

At 405 the user terminal receives additional information about the user using cameras, microphones, biometric sensors, stored user data or other sources. This additional information is based on observing user physical contextual cues at the user interface. These cues may be behaviors or physical parameters, such as facial expressions, eye movements, gestures, biometric data, and tone or volume of speech. Additional physical contextual cues are discussed above. The observed user cues are then interpreted as a user context that is associated with the received statement. To make the association, the user statement and the observed behavior may be limited to within a certain amount of time. The amount of time may be selected based on system responsiveness and anticipated user behavior for the particular implementation. In the case of a user mood indication, for example, while in some cases an observed behavior and the associated statement may be spontaneous, at other times a person may change expressions related to a statement either before the statement or after the statement. As an example, a person may smile before telling joke but not smile while telling a joke. On the other hand a person may smile after telling a joke either at his own bemusement or to suggest that the statement was intended as a joke. Such normal behaviors may be accommodated by allowing for some elapsed time during which the user's behavior or contextual cues are observed.

Alternatively, or in addition, the additional information may include user history activity information, such as e-mail content, messaging content, browsing history, location information, and personal data.

The statement and information may be received and processed at the user terminal. Alternatively, it may be received on a user device and then sent to a remote server. The statement and information may be combined at the user terminal and converted into a format that is appropriate for transmission to the server or it may be sent in a raw form to the server and processed there. The processing may include weighing the statement by the additional information, combining the statement and information to obtain additional context or any other type of processing, depending on the particular implementation.

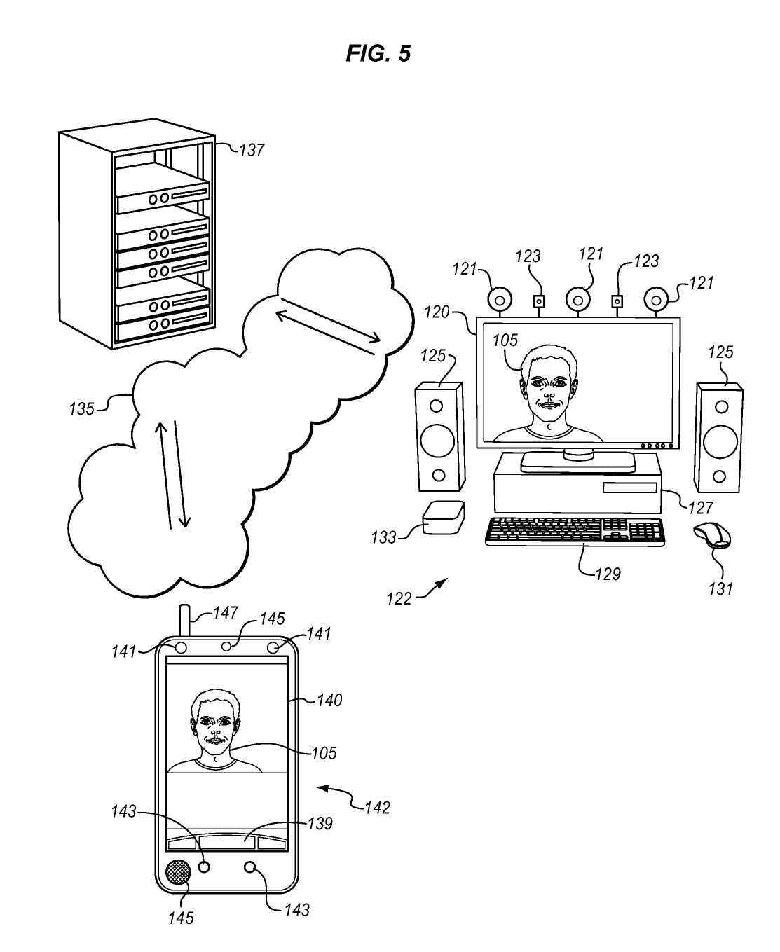

Suitable user terminals 122, 142 are shown in the hardware diagram in FIG. 5. A fixed terminal has a monitor 105 coupled to a computer 127 which may be in the form of a desktop, workstation, notebook, or all-in-one computer. The computer may contain a processing unit, memory, data storage, and interfaces as are well known in the art. The computer is controlled by a keyboard 129, mouse 131, and other devices. A touch pad 133 may be coupled to the computer to provide touch input or biometric sensing, depending on the particular embodiment.

Additional user input is made possible by a sensor array that includes cameras 121 for 3D visual imaging of one or more users and the surrounding environment. Similarly, a microphone array allows for 3D acoustic imaging of the users and surrounding environment. While these are shown as mounted to the monitor, they may be mounted and positioned in any other way depending on the particular implementation.

The monitor presents the conversational agent as an avatar 105 within a dedicated application or as a part of another application or web browser as in FIG. 1. The avatar may be provided with a text interface or the user terminal may include speakers 125 to allow the avatar to communicate with voice and other sounds. Alternatively, the system may be constructed without a monitor. The system may produce only voice or voice and haptic responses. The user may provide input with the camera or camera array or only with a microphone or microphones.

The computing system 122 may provide all of the interaction, including interpreting the user input, and generating conversational responses to drive the avatar. As an alternative or in addition, the user terminal may be further equipped with a network interface (not shown) to an internet 135, intranet or other network. Through the network interface, the computing system may connect through the cloud 135 or a dedicated network connect to servers 137 that provide greater processing and database resources than are available at the local terminal 122. The server 137 may receive user information from the terminal and then, using that information, generate conversational responses. The conversational responses may then be sent to the user terminal through the network interface 135 for presentation on the monitor 120 and speakers 125 of the user terminal.

While a single stack of servers 137 is shown there may be multiple different servers for different functions and for different information. For example, on server or part of a single server may be used for natural conversational interaction, while another server or part of a server may contain navigational information to provide driving instructions to a nearby restaurant. The server or servers may include different databases or have access to different databases to provide different task directed information. The computing system or an initial server may process a request in order to select an appropriate server or database to handle the reply. Sourcing the right database may allow a broader range of accurate answers.

Alternatively, a user terminal 142 may be provided in the form of a slate, tablet, smart phone or similar portable device. Similar to the desktop or workstation terminal 122, the portable user terminal 142 has processing and memory resources and may be provided with a monitor 140 to display the conversational agent and speakers 145 to produce spoken messages. As with the fixed user terminal 122, it is not necessary that an avatar be displayed on the monitor. The monitor may be used for other purposes while a voice for the avatar is heard. In addition, the avatar may be shown in different parts of the screen and in different sizes in order to allow a simultaneous view of the avatar with other items.

One or more users may provide input to the portable user terminal using one or more buttons 139 and a touch screen interface on the monitor 140. The user terminal may also be configured with a sensor array including cameras 141, microphones 143 and any other desired sensors. The portable user terminal may also have internally stored data that may be analyzed or summarized internally. The portable user terminal may provide the conversational agent using only local resources or connect through a network interface 147 to servers 137 for additional resources as with the fixed terminal 122.

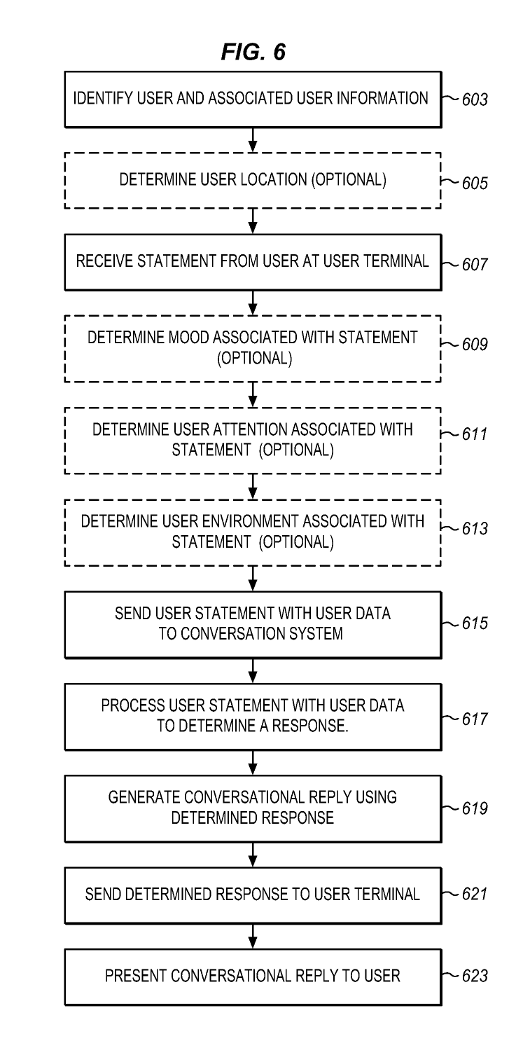

FIG. 6 is a more detailed process flow diagram of providing a conversational agent including many optional operations. At 603 the user is identified and any associated user information is also identified. The user may be identified by login, authentication, observation with a camera of the terminal, or in any of a variety of different ways. The identified user can be linked to user accounts with the conversational agent as well as to any other user accounts for e-mail, chat, web sites and other data. The user terminal may also identify whether there are one or more users and whether each can be identified.

At 605 the user's location is optionally identified. Location information may be used to determine local weather, time, language, and service providers among other types of information. This information may be useful in answering user questions about the news and weather, as well as in finding local vendors, discounts, holidays and other information that may be useful in generating responses to the user. The location of the user may be determined based on information within the user terminal, by a location system of the user terminal or using user account or registration information.

At 607 the user terminal receives a statement from a user. The statement may be a spoken declaration or a question. Alternatively, a statement may be inferred from a user gesture or facial expression. As an example, the user terminal may be able to infer that the user has smiled or laughed. Specific command gestures received on a touch surface or observed by a camera of the terminal may also be interpreted as statements.

At 609 the user terminal optionally determines a mood or emotional state or condition to associate with the received statement. Some statements, such as “close program” do not necessarily require a mood in order for a response to be generated. Other types of statements are better interpreted using a mood association. The determination of the mood may be very simple or complex, depending on the particular implementation. Mood may be determined in a simple way using the user's facial expressions. In this case changes in expression may be particularly useful. The user's voice tone and volume may also be used to gauge mood. The determined mood may be used to weigh statements or to put a reliability rating on a statement or in a variety of other ways.

At 611 the user's attention to the conversational agent or user terminal may optionally be determined. A measure of user attention may also be associated with each statement. In a simple example, if the user is looking away, the conversational agent may be paused until the user is looking again. In another example, if the user is looking away, then a statement may be discarded as being directed to another person in the room with the user and not with the conversational agent. In another example, eye tracking is used to determine that the user is looking away while the user's voice and another voice can be detected. This would indicate that the user is talking to someone else. The conversational agent may ignore the statement or try to interject itself into the side conversation, depending on the implementation or upon other factors. Alternatively, the importance of the statement may simply be reduced in a system for weighing the importance of statements before producing a response. A variety of other weighing approaches may be used, depending on the user of the conversational agent and user preferences. The amount of weight to associate with a statement may be made based only on user mood or using many different user input modalities.

At 613 the user environment is optionally determined and associated with the statement. The environment may include identifying other users, a particular interior or exterior environment or surroundings. If the user statement is “can you name this tree?” then the user terminal can observe the environment and associate it with the statement. If a tree can be identified, then the conversational agent can provide the name. The environment may also be used to moderate the style of the conversational agent. The detection of an outdoor environment may be used to trigger the conversation subsystem to set a louder and less dynamic voice, while the detection of an indoor environment may be used to set a quieter, more relaxed and contemplative presentation style for the avatar.

At 615 the user statement together with any of the different types of additional information described above is sent to the conversation system. The conversation system may be at the local user terminal or at a remote location depending on the particular implementation. The data may be pre-processed or sent in a raw form for processing by the conversational agent. While unprocessed data allows for more of the processing activity to be shifted to the conversational agent, it requires more data to be sent. This may slow the conversation creating an artificial feeling of delay in the replies of the avatar.

At 617, the conversational agent processes the user statement with the accompanying user data to determine an appropriate response to be given by the avatar. The response may be a simulated spoken statement by the avatar or a greater or lesser response. The statement may be accompanied by text or pictures or other reference data. It may also be accompanied by gestures and expressions from the avatar. In some cases, the appropriate response may instead be a simpler utterance, a change in expression or an indication that the avatar has received the statement and is waiting for the user to finish. The appropriate response may be determined in any of a variety of different ways. In one example, the additional data is applied to the conversation system using APIs that apply the additional data to conversational algorithms.

At 619 a conversational reply is generated by the conversation system using the response determined using the statement and additional data. At 621 this determined response is sent to the user terminal and then at 623 it is presented as a conversational reply to user. The operations may be repeated for as long as the user continues the conversation with the system with or without the avatar.

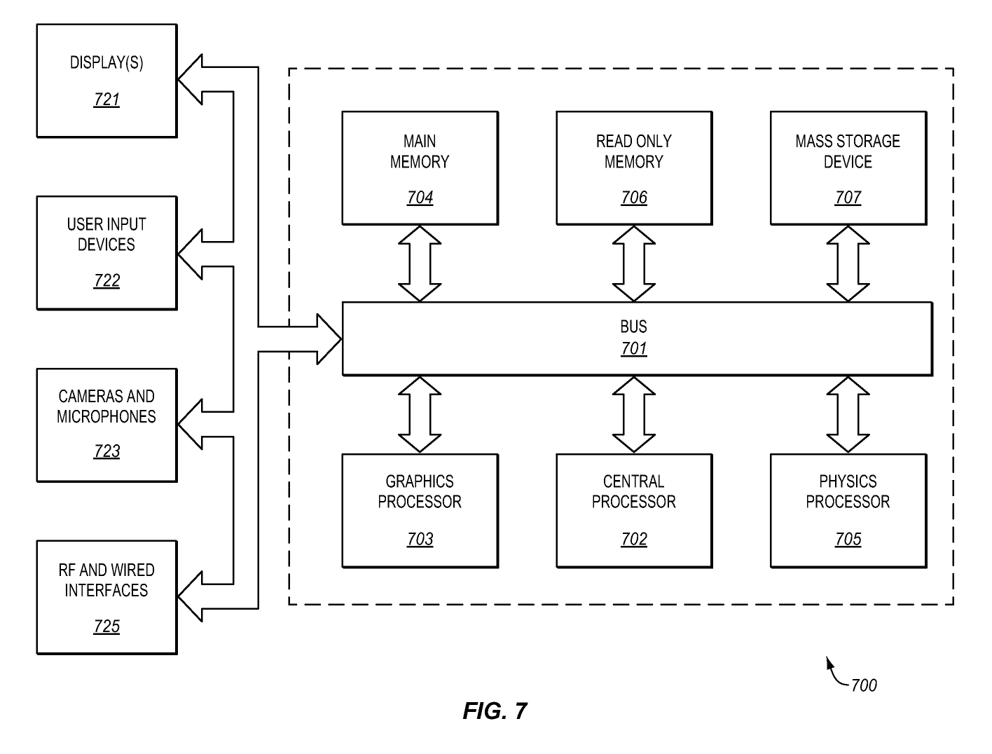

FIG. 7 is a block diagram of a computing system, such as a personal computer, gaming console, smartphone or portable gaming device. The computer system 700 includes a bus or other communication means 701 for communicating information, and a processing means such as a microprocessor 702 coupled with the bus 701 for processing information. The computer system may be augmented with a graphics processor 703 specifically for rendering graphics through parallel pipelines and a physics processor 705 for calculating physics interactions to interpret user behavior and present a more realistic avatar as described above. These processors may be incorporated into the central processor 702 or provided as one or more separate processors.

The computer system 700 further includes a main memory 704, such as a random access memory (RAM) or other dynamic data storage device, coupled to the bus 701 for storing information and instructions to be executed by the processor 702. The main memory also may be used for storing temporary variables or other intermediate information during execution of instructions by the processor. The computer system may also include a nonvolatile memory 706, such as a read only memory (ROM) or other static data storage device coupled to the bus for storing static information and instructions for the processor.

A mass memory 707 such as a magnetic disk, optical disc, or solid state array and its corresponding drive may also be coupled to the bus of the computer system for storing information and instructions. The computer system can also be coupled via the bus to a display device or monitor 721, such as a Liquid Crystal Display (LCD) or Organic Light Emitting Diode (OLED) array, for displaying information to a user. For example, graphical and textual indications of installation status, operations status and other information may be presented to the user on the display device, in addition to the various views and user interactions discussed above.

Typically, user input devices, such as a keyboard with alphanumeric, function and other keys may be coupled to the bus for communicating information and command selections to the processor. Additional user input devices may include a cursor control input device such as a mouse, a trackball, a trackpad, or cursor direction keys can be coupled to the bus for communicating direction information and command selections to the processor and to control cursor movement on the display 721. Biometric sensors may be incorporated into user input devices, the camera and microphone arrays, or may be provided separately.

Camera and microphone arrays 723 are coupled to the bus to observe gestures, record audio and video and to receive visual and audio commands as mentioned above.

Communications interfaces 725 are also coupled to the bus 701. The communication interfaces may include a modem, a network interface card, or other well known interface devices, such as those used for coupling to Ethernet, token ring, or other types of physical wired or wireless attachments for purposes of providing a communication link to support a local or wide area network (LAN or WAN), for example. In this manner, the computer system may also be coupled to a number of peripheral devices, other clients or control surfaces or consoles, or servers via a conventional network infrastructure, including an Intranet or the Internet, for example.

A lesser or more equipped system than the example described above may be preferred for certain implementations. Therefore, the configuration of the exemplary systems 122, 142, and 700 will vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. Specifics in the examples may be used anywhere in one or more embodiments. In one embodiment, a method comprises receiving a statement from a user, observing physical contextual cues, determining a user context based on the observed physical contextual cues, processing the user statement and user context to generate a reply to the user, and presenting the reply to the user on a user interface. In further embodiments observing user physical contextual cues comprises at least one of observing facial expressions, observing eye movements, observing gestures, measuring biometric data, and measuring tone or volume of speech.

Further embodiments may include receiving user history activity information determined based on at least one of e-mail content, messaging content, browsing history, location information, and personal data and wherein processing comprises processing the user statement and user context with the user history activity information.

In further embodiments, receiving a statement from a user comprises receiving a statement on a user device and sending the statement and the additional information to a remote server, or receiving a statement from a user comprises receiving a spoken statement through a microphone and converting the statement to text.

Further embodiments include receiving additional information by determining a location of a user using a location system of a user terminal and processing includes using the determined location.

In further embodiments, processing comprises weighing the statement based on the determined user context, and in some embodiments determining a context comprises measuring user properties using biometric sensors, or analyzing facial expressions received in a camera.

In further embodiments, processing comprises determining a user attention to the user interface and weighing the statement based on the determined user attention.

Further embodiments include determining whether a statement is directed to the user interface using the determined user attention and, if not, then not generating a reply to the statement. In some embodiments if the statement is not directed to the user interface, then recording the statement to provide background information for subsequent user statements.

Further embodiments include receiving the statement and additional information at a server from a user terminal and processing comprises generating a conversational reply to the user and sending the reply from the server to the user terminal. Further embodiments include selecting a database to use in generating a reply based on the content of the user statement. In some embodiments, the selected database is one of a conversational database and a navigational database.

In further embodiments, presenting the reply comprises presenting the reply using an avatar as a conversational agent on a user terminal.

In another embodiment a machine-readable medium comprises instructions that when operated on by the machine cause the machine to perform operations that may comprise receiving a statement from a user, observing physical contextual cues, determining a user context based on the observed physical contextual cues, processing the user statement and user context to generate a reply to the user, and presenting the reply to the user on a user interface.

In further embodiments, processing comprises comparing the user statement to the determined user context to determine if they are consistent and, if not, then presenting an inquiry to the user to explain. Further embodiments include, observing a user facial expression at a time of receiving a user statement associating the user facial expression with a user mood and then presenting an inquiry to the user regarding the associated user mood.

In another embodiment, an apparatus comprises a user input subsystem to receive a statement from a user and to observe user behavior, a user input interpreter to determine a user context based on the behavior, a conversation subsystem to process the user statement and user context to generate a reply to the user, and a system output module to present the reply to the user on a user interface. Further embodiments may also include a cross modality module to combine information received from other user input from the user input subsystem with the statement and the observed user behavior and provide the combined information to the conversation subsystem. Further embodiments may also include a system data summarizer to summarize user stored data about the user and provide a summary of the stored data to the cross modality module.

What is claimed is:

1. A method comprising:
receiving a statement from a user;
observing one or more physical contextual cues;
determining a user context based on the observed physical contextual cues;
processing the user statement and user context to generate a reply to the user; and
presenting the reply to the user on a user interface.

2. The method of claim 1, wherein observing physical contextual cues comprises at least one of observing facial expressions, observing eye movements, observing gestures, measuring biometric data, and measuring tone or volume of speech.

3. The method of claim 1, further comprising receiving user history activity information determined based on at least one of e-mail content, messaging content, browsing history, location information, and personal data and wherein processing comprises processing the user statement and user mood with the user history activity information.

4. The method of claim 1 wherein receiving a statement from a user comprises receiving a statement on a user device and sending the statement and the additional information to a remote server.

5. The method of claim 1, wherein receiving a statement from a user comprises receiving a spoken statement through a microphone and converting the statement to text.

6. The method of claim 1, further comprising receiving additional information by determining a location of a user using a location system of a user terminal and wherein processing includes using the determined location.

7. The method of claim 1, wherein processing comprises weighing the statement based on the determined user mood.

8. The method of claim 7, wherein determining a user context comprises measuring user properties using biometric sensors.

9. The method of claim 7, wherein determining a user context comprises analyzing facial expressions received in a camera.

10. The method of claim 1, wherein determining a user context comprises determining a user attention to the user interface and wherein processing comprises weighing the statement based on the determined user attention.

11. The method of claim 10, further comprising determining whether a statement is directed to the user interface using the determined user attention and, if not, then not generating a reply to the statement.

12. The method of claim 11, wherein if the statement is not directed to the user interface, then recording the statement to provide background information for subsequent user statements.

13. The method of claim 1, further comprising receiving the statement and additional information at a server from a user terminal and wherein processing comprises generating a conversational reply to the user and sending the reply from the server to the user terminal.

14. The method of claim 13, further comprising selecting a database to use in generating a reply based on the content of the user statement.

15. The method of claim 14, wherein the selected database is one of a conversational database and a navigational database.

16. The method of claim 1, wherein presenting the reply comprises presenting the reply using an avatar as a conversational agent on a user terminal.

17. A machine-readable medium comprising instructions that when executed by a machine cause the machine to perform operations comprising:
receiving a statement from a user;
observing one or more physical contextual cues;
determining a user context based on the observed physical contextual cues;
processing the user statement and user context to generate a reply to the user; and
presenting the reply to the user on a user interface.

18. The medium of claim 17, wherein processing comprises comparing the user statement to the determined user context to determine if they are consistent and, if not, then presenting an inquiry to the user to explain the inconsistency.

19. The medium of claim 17, further comprising:
observing a user facial expression at a time of receiving a user statement;
associating the user facial expression with a user mood; and
presenting an inquiry to the user regarding the associated user mood.

20. An apparatus comprising:
a user input subsystem to receive a statement from a user and to observe user behavior;
a user input interpreter to determine a user context based on the behavior;
a conversation subsystem to process the user statement and user context to generate a reply to the user; and
a system output module to present the reply to the user on a user interface.

21. The apparatus of claim 20, further comprising
a cross modality module to combine information received from other user input from the user input subsystem with the statement and the observed user behavior and provide the combined information to the conversation subsystem.

22. The apparatus of claim 21, further comprising a system data summarizer to summarize user stored data about the user and provide a summary of the stored data to the cross modality module.
